(19) United States
(12) Patent Application Publication
(10) Pub. No.: US 2014/0115649 A1
(43) Pub. Date: Apr. 24, 2014

(54) APPARATUS AND METHOD FOR PROVIDING REALISTIC BROADCASTING

(71) Applicant: ELECTRONICS AND TELECOMMUNICATIONS RESEARCH INSTITUTE, Daejeon (KR)

(72) Inventors: Sung-Hee KIM, Daejeon (KR); Hyun-Woo LEE, Daejeon (KR); Seong-Jun BAE, Daejeon (KR); Won RYU, Daejeon (KR)

(73) Assignee: ELECTRONICS AND TELECOMMUNICATIONS RESEARCH INSTITUTE, Daejeon (KR)

(21) Appl. No.: 14/057,976

(22) Filed: Oct. 18, 2013

(30) Foreign Application Priority Data
Oct. 19, 2012 (KR) 10-2012-0116921
May 6, 2013 (KR) 10-2013-0050938

(51) Int. Cl. H04N 21/234; H04N 21/81

(52) U.S. Cl. CPC H04N 21/234; H04N 21/816
USPC 725/116

(57) ABSTRACT

Provided is an apparatus for providing realistic broadcasting, the apparatus including a realistic broadcasting platform configured to divide received content into one or more modalities, curate the content with respect to each of the divided modalities, and generate a scenario based on the curated content and information about one or more realistically reproducing devices which are currently available; and an immersive media gateway configured to generate the information about one or more realistically reproducing devices, and provide a realistic broadcasting service to a user based on the curated content and the information about one or more realistically reproducing devices.

### CROSS-REFERENCE TO RELATED APPLICATION(S)

This application claims the benefit under 35 U.S.C. §119(a) of Korean Patent Application Nos. 10-2012-0116921, filed on Oct. 19, 2012, and 10-2013-0050938, filed on May 6, 2013, in the Korean Intellectual Property Office, the entire disclosures of which are incorporated herein by references for all purposes.

### BACKGROUND

1. Field

The following description relates to a technology for providing a realistic broadcasting service, and more specifically, to an apparatus and method for providing a realistic broadcasting service by configuring a four-dimensional (4D) broadcasting space such that devices reproducing wind, vibration, touch and fragrance are sensed and wind, vibration, touch and fragrance are provided by the devices along with high-quality images and realistic sounds based on sensory information and interaction of multimedia.

2. Description of the Related Art

Realistic broadcasting is a next generation broadcasting service to provide a sense of reality to a user using immersive media. Immersive media is a next generation media to reproduce a real world, and it provides more vivid images with a more enhanced sense of reality. The immersive media can be used in the entertainment industry including broadcasting, movies, and other various industries including computer graphics, display and industrial applications.

The immersive media has been developed since the mid 2000's, mainly on high-definition and stereoscopic technologies. These days, a demand for high quality content service, such as HD TV, 3D TV and 5.1 channel audio, is increasing and content has evolved from visible and audible content to sensory content that satisfies the five senses of a user. Already, the immersive media is adapted in a 4D movie theater or exhibition, and may be, sooner or later, used even at home.

There are various kinds of 3D broadcasting technologies, including multi-view two-dimensional (2D) and/or three-dimensional (3D) TV broadcasting, free-viewpoint broadcasting, ultra high definition (UHD) 3D TV broadcasting and a holographic TV. Furthermore, a technology for converting 2D broadcasting or content into 3D content and outputting the 3D content on a screen of a 3D TV has been introduced. Existing 3D broadcasting technologies are focused on converting 2D images into 3D images, but fail to make various mobile devices interworking with surrounding devices.

A sensory information processing technology has evolved into fusion of human senses to process olfactory and taste information as well as visual, tactile and auditory information. In addition, there is a technology for providing an optimized interactive 3D user interface to a user based on biological information and behavior awareness. A multimedia terminal has been developed into a realistic service providing terminal that is able to include or interwork with the sensory information processor, instead of merely providing images and audio. For example, there are some technologies providing a user with a realistic experience, including a game or other smart phone applications providing visual, auditory and tactile contents; 4D media providing vibration, which is primarily used in an exhibition; a device application providing fragrance using a olfactory function; and even radio broadcasting that fumes scent. However, there is no technology for analyzing a location of a user terminal, information about devices in the surroundings of a user and the user's preference and interconnect the user terminal with adjacent devices related to multimodal information of content based on the analysis result.

Of course, there is a Single-Media Multi-Device (SMMD) technology for interconnecting a single media with multiple devices. Specifically, instead of reproducing media using an audio/video-exclusive reproducing device, the SMMD helps to reproduce media using all the devices which can be controlled by a home server. Nonetheless, the SMMD does not deal with a technique of interconnecting multiple media, that is, multimodal with multiple devices.

Internet Protocol Television (IPTV) is now prevalent and regarded to be suitable for providing an immersive media service of large capacity due to a wide bandwidth of IPTV. For this reason, IPTV is considered as a bidirectional interactive platform. Therefore, an immersive media-based technology or service using IPTV may make it possible to realize a space-time and context-aware immersive media service that helps a user to enjoy a TV program or content more realistically using personal information, including the user's preference, TV watching pattern, dispositions and age, and sensory context information. The realistic IPTV service is expected to be extended as an Internet-based immersive media service that guarantees a high quality and security. To that end, development of a real-time context-aware technology for actively addressing space-time environment information of a user and of a complex immersive media service that is combined with processing sensory context information of content are on progress. This attempt would prompt the use of Internet media platforms and terminals which support smart TVs and Over-The-Top (OTT) as well as IPTV, thereby vitalizing the immersive media industry. In addition, to meet a demand for the Internet-based immersive media service, a web-based media gateway needs to be embodied to be used a realistic broadcasting set top box; a realistic service space for supporting multi sources and multi devices needs to be configured in real time; a smart interaction has to be performed for interaction between multimedia; and a cooperation-based broadcasting platform for performing service curation is needed.

In research and development of the immersive media industry, a method for creating new content and metadata so as to analyze multimodal of content and objecting the multimodal, and a framework for automatically providing a realistic service using cooperation of multimedia, The multimedia service is expected to be used at home in coming days, and SMMD would play an indispensable role for the multimedia service at home. SMMD helps to interconnect a single media with multiple devices. Specifically, instead of reproducing media using an audio/video-exclusive reproducing device, SMMD helps to reproduce media using all the devices which can be controlled by a home server. In addition, a multimedia device is now being developed to include or interwork with a sensory information processor as well as providing images and audio. Furthermore, a technology for combining various kinds of sensory information, including, a location of a terminal, surrounding environment information, and sensory and biological information is adapted in the multimedia device.

For a general user, a realistic broadcasting space is merely a flat space for enjoy 3D content. In order to provide a more realistic broadcasting service, what is required is an environment in which available sensory devices are configured according to a purpose and preference of a user, no matter where the user is placed, to enjoy broadcasting or content. The environment, making a user to feel a sense of reality an image screen and other surrounding sensory devices, is called a 4D realistic broadcasting space. In the 4D realistic broadcasting space, the user can enjoy not only content of the main 3D screen but also other content of ancillary screens that provides other scenes of different time axis, if the ancillary devices are configured to provide corresponding content in accordance with content flows. Therefore, a user is able to watch 3D content, which is mainly audio-visual (AV) content, according to a time line. In addition, in the 4D realistic broadcasting space, multiple devices are used simultaneously according to multimodal of content to provide a more enhanced sense of reality to the user, but it is also possible when the multiple devices are configured to operate according to the content flow.

For example, in the event that images of sensory content deals with audio, video 3D and multi-view and a digital radio relates to audio and touch or audio and fragrance, surrounding environment information of a user is collected. Then, video and 3D content is output to a 3D screen, multi-view content is output to an ancillary screen, and vibration and fragrance is output to a smart phone. By synchronize all the above device3s with each other, a realistic broadcasting service can be provided, To provide the realistic broadcasting service as described above, it is required to converge various technologies, including N-screen technologies and synchronization technologies for interworking multiple devices with each other; 3D high-definition/high-quality image processing and transmitting technologies; sensory information processing technologies for a realistic experience; sensory device technologies, user context-aware processing technologies; and cloud computing technologies for knowledge-based database. The convergence of the above technologies and the provision of an integrated service thereof are possible using corresponding service platform, such as an IPTV service platform, a cloud server, content/media server and a content transfer network. In the present invention, interworking between multiple media and multiple devices and a media gateway function for processing the interworking are not provided,

The immersive media service may be provided in IPTV, smart TV, connected TV and smart devices as well as general broadcasting devices. However, the immersive media service is now merely enjoying 3D broadcasting or content. In addition, IPTV, a typical example of convergence between broadcasting and communications, is expected to be developed into a wired and wireless integration IPTV, Web 2.0-based open IPTV, immersive media service IPTV and context-aware IPTV. Give the above, there is need of developing a technology for providing a realistic service to IPTV. Yet, as described above, there is no technology, environment or method for providing a realistic experience.

### SUMMARY

The following description aims to provide an apparatus and method enabling a user to enjoy realistic broadcasting anytime anywhere by configuring a four-dimensional (4D) broadcasting space such that devices reproducing wind, vibration, touch and fragrance are sensed and wind, vibration, touch and fragrance are provided by the devices along with high-quality images and realistic sounds based on sensory information and interaction of multimedia. To that end, a process for interconnect multimodal media with corresponding devices is proposed. The process realizes Single Media Multi Device (SMMD) or Multi Media Multi Devices (MMMD). That is, it recognizes accessible devices which are able to reproduce media in a form that a user desires anytime and anywhere, and thus it helps to configure a different realistic service space for each user. Therefore, the process may maximize media effects and may be adapted in various kinds of sensory content.

The following description also aims to apply the above technique in a mobile device, so that a user may configure a realistic broadcasting space anytime and anywhere without a set top box. That is, even though a set top box function is not installed in IPTV or smart TV, a smart phone may act as a gateway to configure a realistic broadcasting space and provide a realistic media service. As a result, it is possible to store AV images in a smart phone in real time, to perform routing on the AV images in real time, to scale content suitable for surrounding screens of a user fir display, and to easily enjoy User Interface (UI)/User Experience (UX) of N-screen environment.

In one general aspect, there is provided an apparatus for providing realistic broadcasting, the apparatus including an immersive media gateway configured to generate the information about one or more realistically reproducing devices, and provide a realistic broadcasting service to a user based on the curated content and the information about one or more realistically reproducing devices; and a realistic broadcasting platform configured to divide received content into one or more modalities, curate the content with respect to each of the divided modalities, and generate a scenario based on the curated content and information about one or more realistically reproducing devices which are currently available.

The immersive media gateway and the realistically broadcasting platform may be separate from each other or may be integrated into one device. In addition, the immersive media gateway and the realistically broadcasting platform may be configured to be included in a mobile terminal as an application. The immersive media gateway may calculate location information indicating a physical location of a mobile terminal of a user, searches for one or more realistically reproducing devices accessible on a network based on the location information, and performs polling for the found realistically reproducing devices. The immersive media gateway may search for the one or more realistically reproducing devices based on Internet Protocol (IP) addresses and may search for the one or more realistically reproducing devices connected to the home network based on address system of the home network. The immersive media gateway may map each of the one or more realistically reproducing devices with each modality for reproduction based on curation information included in the received scenario. The immersive media gateway may operate in sync with the one or more realistically reproducing devices.

The realistic broadcasting platform may curate curation information of the content to convert the content according to modalities of the received content, and, if the content is sensory content, curate the content by adding information corresponding to each modality thereof. The generated scenario in the realistic broadcasting platform may be generated by reflecting at least one of a predefined realistic service policy or a user's preference service request. The realistically reproducing device may include at least one of a two-dimensional (2D) image reproducing device, a three-dimensional (3D) image reproducing device, an audio reproducing device, a fragrance generating apparatus and a vibration generating apparatus.

In yet another general aspect, there is provided a method for providing realistic broadcasting, the method including searching for one or more realistically reproducing devices which is currently available, and generating realistically reproducing device information; generating sensory content by curating each of one or more modalities in received content; generating a scenario based on the sensory content and the realistically reproducing device information; configuring a realistic broadcasting space based on the generated scenario; and providing a realistic broadcasting service to a user using one or more realistically reproducing devices composing the realistic broadcasting space.

The generating of the scenario may include converting the received content into the sensory content by curating curation information included in the content according to each modality of the content; and generating the scenario by reflecting a predefined realistic service policy or a user's preference service request to the converted sensory content. The generating of the realistically reproducing device information may include calculating location information indicating a physical location of a mobile terminal of a user; searching for one or more realistically reproducing devices accessible on a network based on the location information and performing polling for the found realistically reproducing devices; and generating the realistically reproducing device information about the found realistically reproducing devices.

Other features and aspects may be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a configuration of an apparatus for providing realistic broadcasting according to an exemplary embodiment of the present invention;

FIG. 2 is a diagram illustrating in detail a configuration of an apparatus for providing realistic broadcasting according to an exemplary embodiment of the present invention;

FIG. 3 is a block diagram illustrating a method for providing realistic broadcasting by the apparatus shown in FIG. 1 according to an exemplary embodiment of the present invention;

FIG. 4 is a flow chart illustrating a method for providing realistic broadcasting according to an exemplary embodiment of the present invention;

FIG. 5 is a flow chart illustrating a method for providing realistic broadcasting using a mobile terminal according to an exemplary embodiment of the present invention;

FIG. 6A is a block diagram illustrating an example of a service of an apparatus for providing realistic broadcasting according to an exemplary embodiment of the present invention; and

FIG. 6B is a block diagram illustrating an example of a service of an apparatus for providing realistic broadcasting according to another exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

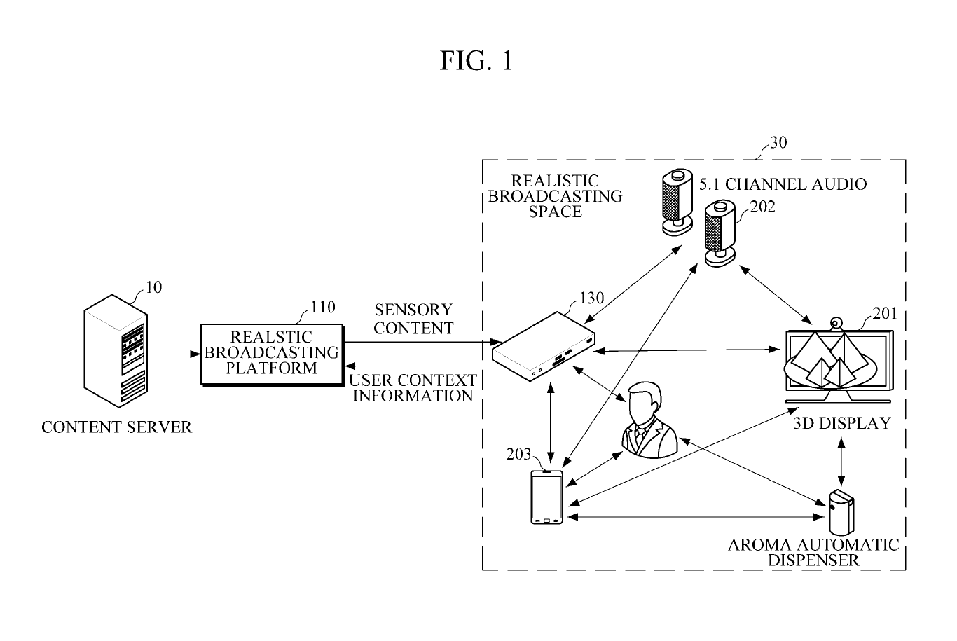

FIG. 1 is a diagram illustrating an apparatus for providing realistic broadcasting according to an exemplary embodiment of the present invention.

Referring to FIG. 1, an apparatus 100 for providing realistic broadcasting includes a realistic broadcasting platform 110 and an immersive media gateway 130.

The realistic broadcasting platform 110 receives various kinds of content for a realistic broadcasting service from a content server 10. The content server 10 may include a three-dimensional (3D) or four-dimensional (4D) content, two dimensional (2D) image or 2D application and 5.1 channel. The realistic broadcasting platform 110 provides the realistic broadcasting service to a user by configuring a realistic broadcasting space 30 by interworking with a plurality of a realistically reproducing device 200 based on contents received from the content server and information about the realistically reproducing devices, which is received from the immersive media gateway 130. In order to provide a realistic broadcasting service to a user, the realistic broadcasting platform 110 generates, based on the received contents, sensory content that including a scenario, content modalities and service curation. The realistic broadcasting platform 110 transmits the generated sensory content to the immersive media gateway 130.

The realistic broadcasting platform 110 receives from the immersive media gateway 130 user context information that includes information about a realistically reproducing device and user information. In addition, the realistic broadcasting platform generates sensory content by curating content to be reproduced such that the received user context information and curation context information extracted from the received content are analyzed. Then, the realistically broadcasting platform stores the generated sensory content in a database. Next, the realistic broadcasting platform determines a policy on how to reproduce the sensory content, and generate a scenario on how to provide the realistic broadcasting service.

The realistic broadcasting platform 110 transmits to the immersive media gateway 130 the sensory content that includes the generated scenario, content modalities extracted from the received content and service curation.

The immersive media gateway 130 senses a plurality of realistically reproducing devices 201, 202, 203 and 204 capable of providing a realistic broadcasting service in a place where a user is located.

The media gateway 130 selects one or more realistically reproducing devices 201, 202, 203 and 204 capable of providing an immersive media service by interworking with the apparatus 100 for providing realistic broadcasting from among various media devices in a predetermined radius from the place where the user is located. The immersive media gateway 130 may search for one or more realistically reproducing devices 201, 202, 203 and 204 from among a plurality of media devices by searching for devices located within a specific range using wireless local area network (LAN) interface, such as Bluetooth and WiFi, or using wired LAN interface, such as IP communications, and then select one or more realistically reproducing devices 201, 202, 203 and 204 capable of providing a realistic broadcasting service from among a plurality of found media devices. In addition, the immersive media gateway 130 may search for the realistically reproducing device 200 from a plurality of media devices composing a home network.

The immersive media gateway 130 generates realistically broadcasting device information that refers to information about one or more selected realistically reproducing devices 201, 202, 203 and 204. Further, the immersive media gateway 130 generates user information including a profile of a user and all the media devices possessed by the user. The immersive media gateway 130 transmits, to the realistic broadcasting platform 110, user context information that includes the generated information about a realistically broadcasting device and the generated user information.

The immersive media gateway 130 configure a realistic broadcasting space by grouping the found realistically reproducing devices 200 into one based on the sensory content received from the realistic broadcasting platform 110. The realistic broadcasting space refers to a service space in which the currently-available realistically reproducing devices 201, 202, 203 and 204 voluntarily sensed and registered by the immersive media gateway 130 is rearranged according a usage purpose of the user to a to reproduce content modalities realistically. The content modalities include sensory data displayed in content.

Next, each of the realistically reproducing devices 201, 202, 203 and 204 controls operations thereof, and provide a content including sensory data to the user using the realistically reproducing devices 201, 202, 203 and 204. According to a type of the sensory data included in the content modalities, it is possible to provide realistic broadcasting to a user using the various kinds of the realistically reproducing devices 201, 202, 203 and 204. According to a type of the sensory data, visible sense may be displayed in a three-dimensional TV, ultra high definition (UHD) TV or an holographic image reproducing device 201; auditory sense may be reproduced by an audio reproducing device 202, such as a 5.1 CH audio; tactile sense may be provided by a vibration experience device 203; and olfactory sense may be provided by an olfactory sense experience device 204 capable to reproduce fragrance. The realistically reproducing devices 201, 202, 203 and 204 are not limited to the above four devices, and may include various kinds of devices capable of providing sensory data.

By controlling the realistically reproducing device 200 constituting a realistic broadcasting space based on the sensory content so as to stream the sensory content, the immersive media gateway 130 provide3s a realistic broadcasting service to a user. For example, if content provided from the content server 10 is movie content, the immersive media gateway 130 may reproduce an image using a three-dimensional display device, operates a vibration sensor 202 at a collision scene, and provides smell of smoke at the conflagration scene using an olfactory sensor 204. In this manner, a user may be provided with a more realistic broadcasting service.

The immersive media gateway 130 may be configured as a set top box or may be installed in one of an image reproducing device or a different realistically reproducing device 200. In addition, the immersive media gateway 130 may be embodied in a smart device, such as smart phone and Tablet PCs.

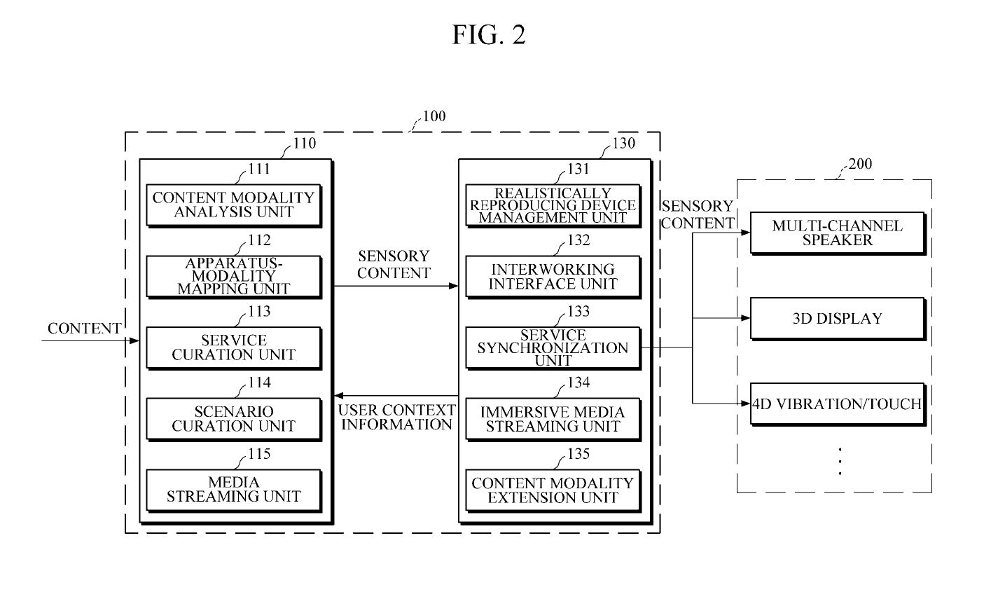

FIG. 2 is a diagram illustrating in detail an apparatus for providing realistic broadcasting according to an exemplary embodiment of the present invention.

Referring to FIG. 2, an apparatus 100 for providing realistic broadcasting includes a realistic broadcasting platform 110 and an immersive media gateway 130.

The realistic broadcasting platform includes a content modality analysis unit 111, a device-content modality mapping unit, a service curation unit 113, a scenario-configuration unit 114 and a media streaming unit 115.

The content modality analysis unit 111 analyzes content multimodal information included in content received from a content server and extracts information about a requesting device from the analyzed content multimodal information. Content for a realistic broadcasting service includes the content multimodal information that makes enables provision of a realistic experience to a user. The content multimodal information may include image information for visual sense, audio information for auditory sense, tactile information for tactile sense and olfactory information for olfactory sense. The image information for visual sense may include not only information about a two-dimensional image screen which is commonly used, but also information about a three-dimensional image screen or a holographic image. The audio information for auditory sense may include audio information of various data formats and diverse quality, from stereo sound to 5.1 channel sounds. The tactile information for tactile sense is information required for providing tactile sense, such as vibration, at a predetermined point in time in sync with image information or audio information. The olfactory information for olfactory sense is information required for providing olfactory sense, such as vibration, at a predetermined point in time in sync with image information or audio information.

The content modality analysis unit 111 extracts requesting-device information in order to screen out relevant devices based on the content modality information. That is, the content modality analysis unit 111 checks the need of an image reproducing device based on the image information, the need of an audio reproducing device based on the audio information, the need of a tactile sensory device based on the tactile information, and the need of a olfactory sense providing device based on the olfactory information. That is, based on content modality information, the content modality analysis unit 111 checks each type of five sensory devices necessary for providing a realistic image service.

The device-content modality mapping unit 112 compares requesting-device information, which is extracted in the content modality analysis unit 111 through the analysis of the content modality information, with realistically reproducing device information generated in the immersive media gateway 130 so as to define correlation between a requesting device and a realistically reproducing device. The requesting device information extracted in content modality analysis unit 111 includes information about types of five sensory devices required for providing a realistic image service about received content. The realistically reproducing device information generated in the immersive media gateway 130 includes a list of one or more realistically reproducing devices capable of currently providing a realistic service, the realistically reproducing devices which are selected from among a plurality of media devices existing within a predetermined range. By comparing the requesting device information with the realistically reproducing device information, the device-content modality mapping unit 112 maps the realistically reproducing device 200 with corresponding sensory information. That is, the device-content mobility mapping unit 112 senses types of realistic services necessary to provide realistic broadcasting with respect to content received using the requesting device information, and maps each sensed realistic service to a realistically reproducing device among currently-available realistically reproducing devices which are specified in the realistically reproducing device information. In addition, the device-content mobility mapping unit 112 generates immersive media mapping information that defines correlation between a mobility of the content and the realistically reproducing device.

The service curation unit 113 generates a service scenario necessary to provide a realistic broadcasting service to a user by reconfiguring content reproduction based on the immersive media mapping information and the content modality information. In addition, the scenario configuration unit 114 generates scenario configuration information including a point in time and details of an operation with respect to each of one or more realistically reproducing devices 200 by setting conditions for reproduction of the service scenario generated in the service curation unit 113.

The media streaming unit 115 transfers sensory content, which include the scenario configuration information generated in the scenario configuration unit 114 and curated content, to the immersive media gateway 130. The sensory content includes information required for providing a user with a realistic broadcasting service by controlling one or more realistically reproducing devices 200 using the immersive media gateway 130. Based on the sensory content, one or more realistically reproducing devices 200 provide different realistic services at different points in time.

The immersive media gateway 130 includes a realistically reproducing device management unit 131, an interworking interface 132, a service synchronization unit 133, an immersive media streaming unit 134 and a content modality extension unit 135.

The realistically reproducing device management unit 131 senses and searches for one or more realistically reproducing devices 200 capable of providing a realistic broadcasting service in an area in which the user is located. From among a plurality of media devices existing within a predetermined range, the realistically reproducing device management unit 131 selects one or more realistically reproducing device 200 which is capable of providing an immersive media service by interworking with the apparatus 100. Specifically, the realistically reproducing device management unit 131 searches for a plurality of media devices existing within a predetermined range, and select a media device, which is equipped with interworking interface 132 and able to interwork with the realistically reproducing device management unit 131, as a realistically reproducing device 200 from among a plurality of media devices.

Then, the realistically reproducing device management unit 131 groups one or more selected realistically reproducing devices 200 into one to thereby configure a realistic broadcasting space 150. The realistic broadcasting space 150 refers to a service space that is configured such that the currently-available realistically reproducing devices 200 voluntarily sensed and registered by the realistically reproducing device management unit 131 are rearranged according to a usage purpose of a user to thereby reproduce modality of content more realistically. The realistically reproducing device management unit 134 generates realistically reproducing device information about one or more realistically reproducing devices 200 composing the realistic broadcasting space 150, and transfers the realistically reproducing device information to the realistic broadcasting platform 110.

The interworking interface 132 is a uniform-standard interface necessary for communication and content modality association between the immersive media gateway 130 and each of one or more realistically reproducing devices 200 composing the realistic broadcasting space 150. The immersive media gateway 130 may provide a realistic broadcasting service by grouping the realistically reproducing devices 200 into one to configure a realistic broadcasting space 150 using the interworking interface 132. The immersive media gateway 130 transfers sensory content, which including the scenario configuration information received from the realistic broadcasting platform 110 and content, to one or more realistically reproducing devices 200 through the interworking interface 132.

Based on the scenario configuration information included in the sensory content received from the realistic broadcasting platform 110, the service synchronization unit 133 controls two or more realistically reproducing devices 200, which compose a realistic broadcasting space, to be synchronized. Using realistically reproducing devices which are synchronized with the immersive media gateway 130 using the service synchronization unit 113, a user may be provided with a realistic broadcasting service enabling realistic experience at an appropriate point in time.

With respect to the realistic broadcasting platform 110, the immersive media streaming unit 134 transmits and receives the sensory content that includes the scenario configuration information and content.

The content modality extension unit 135 extends modality of received content. For example, the content modality extension unit 135 may analyze received two-dimensional content to extract sensory elements therefrom and convert the two-dimensional (2D) content into three-dimensional (3D) content based on the extracted sensory elements.

The realistically reproducing device 200 provides a user with a realistic service for a realistic experience based on the received scenario configuration information and the received content. To that end, the realistically reproducing device 200 may be equipped with an interworking interface, which is the same interworking interface of the immersive media gateway 130, and a service synchronization unit 133 which is between the immersive media gateway 130 and each of different realistically reproducing devices 200 to maintain association synchronization thereof.

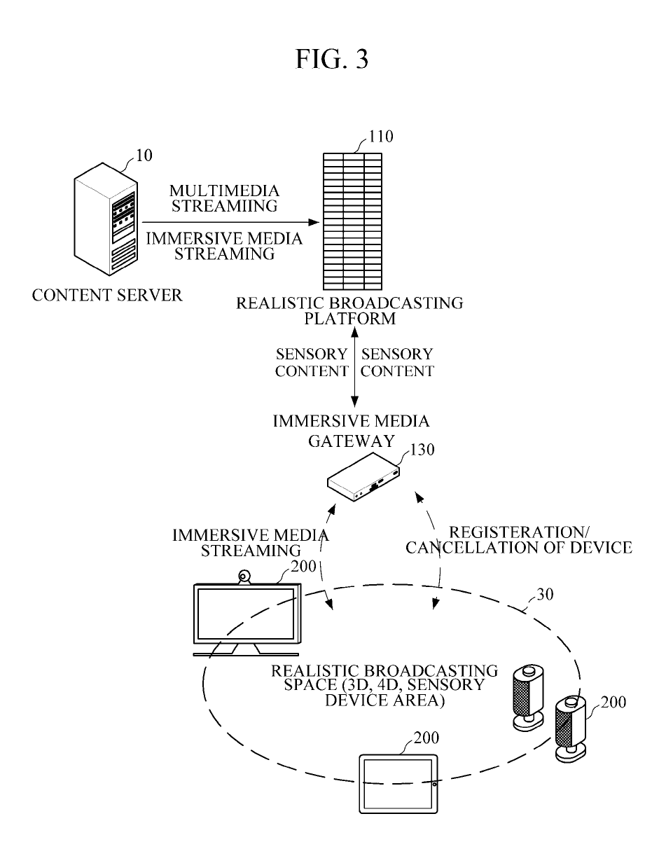

FIG. 3 is a diagram illustrating a process of providing realistic broadcasting in an apparatus for providing realistic broadcasting according to an exemplary embodiment of the present invention.

Referring to FIG. 3, in the process of providing realistic broadcasting in an apparatus 100 for providing realistic broadcasting, a content server 10 provides various multimedia content and immersive media content, which is created for a realistic service, to a realistic broadcasting platform 110. The realistic broadcasting platform 110 generates sensory content including service curation and a scenario by analyzing the multimedia content and the immersive media content, and transfers the sensory content to an immersive media gateway 130 along with content. The immersive media gateway 130 configures a realistic broadcasting space 30 by registering one or more realistically reproducing devices 200 based on the received sensory content, and then manage and/or disassemble the realistically reproducing devices, provides immersive media streams and reproduces the streams.

The immersive media gateway 130 may be configured as a separate set top box or as an inner configuration of an image reproducing device, such as TV. In addition, the immersive media gateway 130 may be embodied as a web application in a smart device, such as smart TVs and connected TVs. Further, all or some of the configurations of the immersive media gateway 130 may be embodied as a web application in a mobile terminal, such as smart phones and tablet PCs.

The realistic broadcasting platform 110 may be embodied as a device separate from or combined with the immersive media gateway 130. For example, the realistic broadcasting platform 110 and the immersive media gateway 130 may be embodied as a single set top box or may be included in a smart TV.

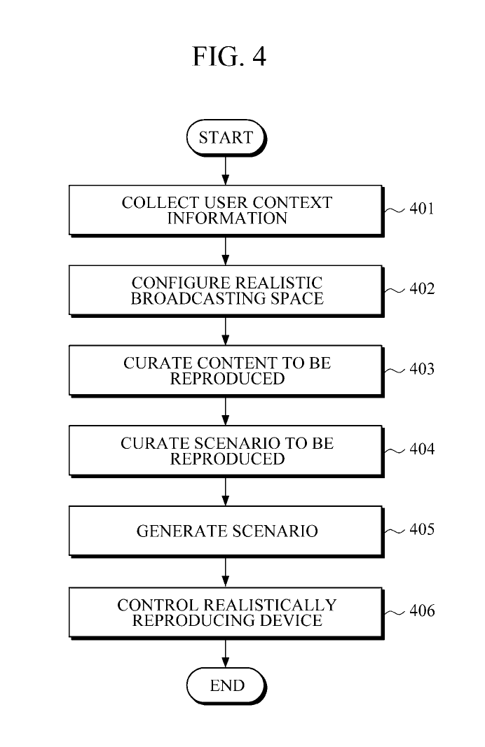

FIG. 4 is a diagram illustrating a scenario of an apparatus for providing realistic broadcasting to provide realistic broadcasting according to an exemplary embodiment of the present invention.

TABLE 1
Table 1 shows examples of realistic broadcasting provided
by an apparatus for providing realistic broadcasting according
to an exemplary embodiment of the present invention.

| | |
|---|---|
| Real-time presentation | Targeted service customer: absent |
| (assembly, speech, | members/people watching in a remote |
| seminar, education, | distance |
| sermon, promotion) | realistic experience by extending 2D |
| | broadcasting into 3D broadcasting |
| | installation of an immersive media gateway |
| | in IPTV/smart TV |
| | Utilization of a smart phone as an immersive |
| | media gateway |
| UI/UX enhanced | Targeted service customers: people having |
| content | smart-terminal content |
| (game, navigation) | realistic experience by extending 2D |
| | broadcasting into 3D broadcasting |
| | Utilization of a smart phone as a |
| | tactility/feeling input/output pad |
| Non real-time sensory | Targeted service customers: entertainment |
| content (satellite | realistic experience by configuring a |
| broadcasting, | realistic environment according to content |
| promotion | multimodality |
| broadcasting, art | realistic experience of multi-channel audio, |
| performance, drama, | 3D extension, vibration, multi-angled/multi-view |
| sports broadcasting, | scene, feeling, motion by interworking with |
| museum, tour | an external A/V device, a 3D screen, a 4D chair, |
| information) | a multi-vision and smart phone UI/UX |

Referring to Table 1, if a person is unable to participate in presentation conducted at a remote distance, it is possible to configure a realistic broadcasting space using realistically reproducing devices existing in an area where the person is located and to convert 2D presentation content into a 3D image or a 4D experience service, so that the person may enjoy the presentation more realistically at a remote distance. For a presentation experience service, a user may install an immersive media gateway in Internet Protocol Television (IPTV), smart TV and a set top box, and then extend the 2D presentation into 3D using the installed immersive media gateway to receive a realistic broadcasting service.

In addition, a user may enjoy a game content experience service, such as a game and navigation, which highly requires User Interface (UI) and User Experience (UX), through vibration, motion, touch and an olfactory experience as well as a visual and auditory experience. A user may enjoy the user interface and user experience-enhanced content by installing an immersive media gateway application in a smart phone and by using the smart phone as an input/output device for tactile and motion game content. That is, the user may configure a realistic broadcasting space using a smart phone at any time in anywhere including home and an office.

Non real-time sensory content, such as satellite broadcasting, promotion broadcasting, art performance, drama, sports broadcasting, museum and tour information, may include various kinds of modality in content. By analyzing the non-real-time sensory content including various modalities, extracting the modalities and configuring a realistic broadcasting space in which a realistic experience may be provided according to the extracted modalities, it is possible to provide a user with a more realistic experience. At each scene of content, various kinds of realistically reproducing devices may be provided and used in the realistic broadcasting space, including an external AV device, a 3D screen, a 4D chair, a multi-vision, and a fragrance generating device.

FIG. 4 is a flow chart illustrating a method for providing realistic broadcasting according to an exemplary embodiment of the present invention.

Referring to FIG. 4, a choreographer service of an apparatus for providing realistic broadcasting refers to a process of configuring a realistic broadcasting space and providing sensory content using the apparatus for providing realistic broadcasting. The method for providing realistic broadcasting starts out by receiving user context information in 401. The user context information includes realistically reproducing device information and user information about a profile collected from a user. Specifically, the realistically reproducing device information is about realistically reproducing devices possessed by a user and currently-available realistically reproducing devices. That is, the realistically reproducing device information is information about realistically reproducing devices used as a media device to provide a realistic broadcasting service to the user. One or more realistically reproducing devices are selected from among a plurality of media devices existing in a predetermined range from a user. The selected realistically reproducing devices configure a realistic broadcasting space in 402. Upon reception, the user information and the realistically reproducing device information are stored in a database.

Then, content to be reproduced are curated by analyzing the user context information and curation context information extracted from the content in 403. Specifically, content multimodal information included in the received content is analyzed. The content multimodal information may include image information for visual experience, audio information for auditory experience, tactile information for tactile experience and olfactory information for olfactory experience. By reconfiguring content reproduction based on the content modality information, a content to be reproduced is curated.

Then, a policy about a scenario to be reproduced is set in 404. That is, a policy on how to reproduce the content to be reproduced, that is, sensory content, is set. Then, a scenario is generated based on the set policy in 405. The scenario includes control commands required for providing sensory content using one or more realistically reproducing devices composing a realistic broadcasting space. That is, the scenario is information required for providing the sensory content by controlling each realistically reproducing device composing a realistic broadcasting space.

One or more realistically reproducing devices composing the realistic broadcasting space is controlled based on the generated scenario in 406. That is, one or more realistically reproducing devices composing the realistic broadcasting space is controlled based on the generated scenario to thereby provide the sensory content. For example, an image reproducing device continues to reproduce images of received content, and a tactile experience apparatus, such as a vibration device, simultaneously provide vibration experience at a time when a conflagration scene or a collision scene is reproduced in the image reproducing device.

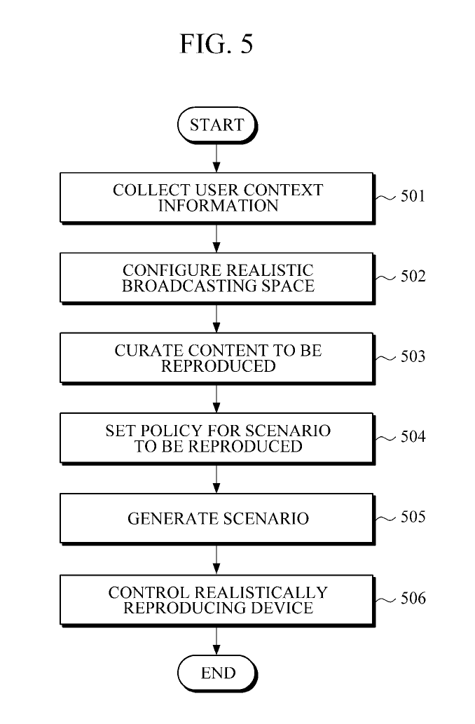

FIG. 5 is a flow chart illustrating a method for providing realistic broadcasting using a mobile terminal according to an exemplary embodiment of the present invention.

Referring to FIG. 5, in the method for providing realistic broadcasting using a mobile terminal, an immersive media gateway, a realistic broadcasting platform and the mobile terminal may be configured to be separate or the immersive media gateway and the realistic broadcasting platform may be included in the mobile terminal. A service choreographer application is an application for providing a realistic broadcasting service. Using the service choreographer application, the immersive media gateway, the realistic broadcasting platform and the mobile terminal interwork with each other to thereby provide sensory content to a user. If the immersive media gateway is included in the mobile terminal, an immersive media gateway application is executed. If the immersive media gateway is configured to be separate from the mobile terminal, the immersive media gate way is executed and then connected to the mobile terminal.

For a starter, a service location is computed in 501. The immersive media gateway calculate location information of the mobile terminal; searches for realistically reproducing devices which are currently accessible on a network of the mobile terminal based on the calculated location information of the mobile terminal; and performs polling operation for the found realistically reproducing devices in 502. At this point, the network may be based on an IP address. If a home network is configured, realistically reproducing devices connected to the home network is searched according to address system of the home network.

Then, the found realistically reproducing devices found around a smart phone are registered in 503. That is, one or more found realistically reproducing devices are registered as currently-available realistically reproducing devices, and registration is cancelled with respect to a non-available realistically reproducing device among previously-registered realistically reproducing devices. Information about the registered realistically reproducing devices is used as information for service curation. User context information, which includes the information about the registered realistically reproducing devices and user information, is transferred to the realistic broadcasting platform.

The realistic broadcasting platform receives the user context information from the immersive media gateway in 504. The realistic broadcasting platform converts the user context information into information necessary for content curation. Then, the realistic broadcasting platform compares the converted user context information with a profile of each realistically reproducing device to configure proper correlation between the converted user context information and each realistically reproducing device, and stores the correlation in a database in 505. Specifically, the realistic broadcasting platform curates original content to be converted into sensory content suitable for modalities of the original content in 506. If the content is sensory content, the realistic broadcasting platform curates the content by adding information corresponding to each modality thereof. For example, the realistic broadcasting platform divides the received content into one or more modalities, such as 3D display, vibration, fragrance and touch, and curate the content to be converted into sensory content suitable for each modality of the content. The curated original content is divided into each type of sensory content to thereby be in the database.

If the content is curated, the realistic broadcasting platform a reproduction scenario planning in 507. At this point, a predefined realistic service policy is reflected or a user's preference service request is reflected. Then, a scenario based on the reproduction scenario is generated in 508. Based on the reflected realistic service policy or the preference service requests, a scenario required for providing a user with immersive broadcasting using the sensory content is generated. The generated scenario may include the curated content, modality information, information about relevant realistically reproducing devices and user location service information.

If the scenario is generated, the realistic broadcasting platform transfers the sensory content to the immersive media gateway in 509. The sensory content includes the curated content and the generated scenario. If curating the content and generating the scenario based on the reproduction scenario planning, the realistic broadcasting platform provides streams of the sensory content, which includes the curated content and the generated scenario, to the immersive media gateway.

If receiving the sensory content from the realistic broadcasting platform, the immersive media gateway determines realistically reproducing devices to reproduce each modality, based on curation information included in the sensory content in 510. The curation information included in the received sensory content includes one or more modalities. Thus, each of one or more modalities is mapped to a corresponding realistically reproducing device. For example, a modality related to a 3D image may be mapped to a 3D image reproducing device; a modality related to touch and vibration may be mapped to a vibration apparatus; and a modality related to olfactory sense may be mapped to a fragrance generating apparatus.

In addition, the immersive media gateway transfers the sensory content to the determined realistically broadcasting devices in 511. That is, the sensory content is transferred to one or more realistically reproducing devices, each apparatus which is mapped with corresponding modality information. It is possible to transfer the sensory content to a single realistically reproducing device at one time or to two or more realistically reproducing devices simultaneously.

If receiving the sensory content from the immersive gateway, each realistically reproducing device is synchronized with the immersive media gateway in 512. The realistic broadcasting service is a service to provide a realistic experience service using one or more realistically reproducing devices based on a scenario. If two or more realistically reproducing devices are not in sync with the immersive media gateway, an error may occur when providing the realistic experience service. For example, at an explosion scene requiring vibration experience, if realistically reproducing devices are not synchronized with the immersive media gateway, vibration experience may not be provided at the explosion scene due to a network connection status or performance of each realistically reproducing device. For this reason, one or more realistically reproducing devices have to be synchronized with the immersive gateway that provides streams of the sensory content.

Each synchronized realistically reproducing device reproduces the sensory content in 513. One or more realistically reproducing devices reproduce the received sensory content and provide different realistic experiences.

In FIG. 5, the method for providing realistic broadcasting using a mobile may further include an operation of setting a streaming session between the mobile terminal, the immersive media gateway and the realistic broadcasting platform to set a session for providing streams of the sensory content. The operation of setting a streaming session may be performed at a point in time when connection is required during all the processes for receiving the sensory content including content and a scenario from the realistic broadcasting platform. In addition, the operation of setting a streaming session includes an operation of setting an interface to transfer the content to realistically reproducing devices existing within a realistic broadcasting space according to modality of the content.

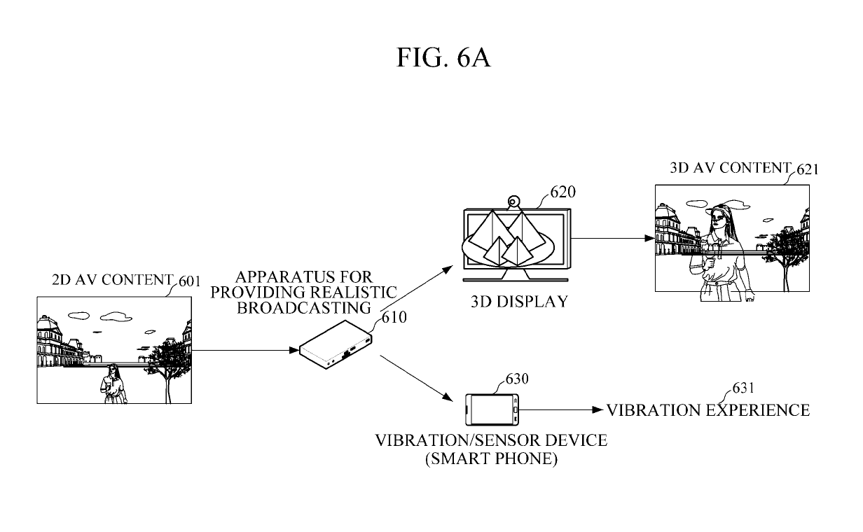

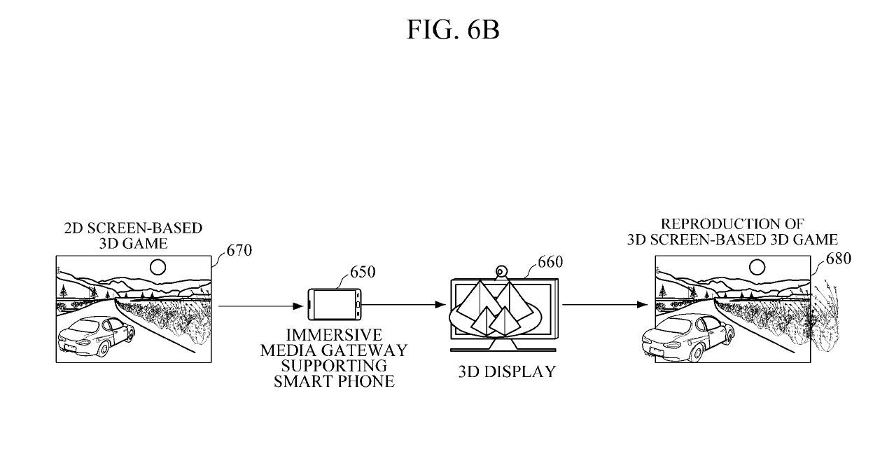

FIG. 6A is a block diagram illustrating an example of a service provided by an apparatus for providing realistic broadcasting according to an exemplary embodiment of the present invention, and FIG. 6 B is a block diagram illustrating an example of a service provided by an apparatus for providing realistic broadcasting according to another exemplary embodiment of the present invention.

Referring to FIG. 6A, an example of a realistic broadcasting service provided by an apparatus for providing realistic broadcasting includes an apparatus 610 for providing realistic broadcasting, a 3D image reproducing device 620 and a vibration generating apparatus 630.

For a starter, the apparatus 610 searches for realistically reproducing devices which are available using IP addresses or connection to a home network. The 3D image reproducing device 620 and the vibration generating apparatus 630, which are found in the above search operation, are registered. Then, if receiving 2D image content 601 from a content server, the apparatus 610 analyses the received 2D image content 601 to extract content modality, converts the content into sensory content by curating the content, and then generate a scenario based on the sensory content. The apparatus 610 transfers the sensory content to the 3D image reproducing device 620 and the vibration generating apparatus 630, and controls the 3D image reproducing device 620 and the vibration generating apparatus 630 based on the generated scenario. Using the 3D image reproducing device 620, a user may convert the 2D image content 601 into 3D image content 602 and thus watch 3D stereoscopic images. In addition, the user may enjoy vibration experience 603 at a predetermined point in time using the vibration generating apparatus 630 based on the generated scenario.

In FIG. 6B, an example of a realistic broadcasting service provided through a mobile terminal include a realistic broadcasting providing mobile terminal 650 and a 3D display 660.

The realistic broadcasting providing mobile terminal 650 includes a realistic broadcasting platform and an immersive media gateway. Each of the realistic broadcasting platform and the immersive media gateway may be embodied as an application. If receiving a 2D screen-based 3D game 670, the realistic broadcasting providing mobile terminal 650 analyzes modalities of the 2D screen-based 3D game 670 into 3D stereoscopic images and reproduce a 3D-based 3D game 680 using the 3D display 660.

The method for providing a realistic broadcasting service by an apparatus for providing realistic broadcasting according to an exemplary embodiment of the present invention may be called a choreographer service. The present invention provides a realistic experience using realistically reproducing devices based on a generated scenario. Just like a choreographer who directs proper performance at a predetermined point in time according to a predetermined choreography, one or more realistically reproducing devices provide an appropriate experience service in a predetermined point in time based on the generated scenario according to an exemplary embodiment of the present invention.

In the above embodiments of the present invention, an apparatus and method for providing realistic broadcasting are useful and effective for users who wishes to enjoy real-time presentation broadcasting using media at home or in the office when the users are unable to attend the presentation. In addition, it is possible to provide a realistic experience to users, who want to feel broadcasting, art performance, promotion broadcasting and cultural property content more vividly, by spontaneously configuring a realistic broadcasting space.

In addition, the present invention is effective in configuring a media environment that satisfies the five senses of human, including a visual sense and an auditory sense. In addition, it helps to gives a sense of reality to a user when enjoying content at home, in the office, in a 4D movie theater and in an experience. Furthermore, it may be applied in all kinds of media, including realistic movies, news content and documentaries, and may be used in devices and environment using multiple media, such as complex device interworking cyber education, cultural property exhibition, model houses, games, home entertainment and a car navigation system.

Since the present invention may be used with open IPTV, smart TV, internet broadcasting and smart phone, it inevitably requires extension of N-screen services. As a result, it may lead to development of a technology for creating immersive media and relevant metadata for a realistic service and a technology for processing and transmitting high-definition/high-quality multimodal images. In addition, it is possible to use a mobile device as a means for configuring a realistic broadcasting space, so that an additional set top box does not need to be installed and thus a space for an additional device is unnecessary.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for providing realistic broadcasting, the apparatus comprising:
a realistic broadcasting platform configured to divide received content into one or more modalities, curate the content with respect to each of the divided modalities, and generate a scenario based on the curated content and information about one or more realistically reproducing devices which are currently available; and
an immersive media gateway configured to generate the information about one or more realistically reproducing devices, and provide a realistic broadcasting service to a user based on the curated content and the information about one or more realistically reproducing devices.

2. The apparatus of claim 1, wherein the immersive media gateway and the realistic broadcasting platform is comprised in a mobile terminal as an application.

3. The apparatus of claim 1, wherein the immersive media gateway calculates location information indicating a physical location of a mobile terminal of a user, searches for one or more realistically reproducing devices accessible on a network based on the location information, and performs polling for the found realistically reproducing devices.

4. The apparatus of claim 1, wherein the immersive media gateway searches for the one or more realistically reproducing devices based on Internet Protocol (IP) addresses.

5. The apparatus of claim 1, wherein the immersive media gateway searches for the one or more realistically reproducing devices connected to the home network based on address system of the home network.

6. The apparatus of claim 1, wherein the realistic broadcasting platform curate curation information of the content to convert the content according to modalities of the received content, and, if the content is sensory content, curate the content by adding information corresponding to each modality thereof.

7. The apparatus of claim 1, wherein the generated scenario is generated by reflecting at least one of a predefined realistic service policy or a user's preference service request.

8. The apparatus of claim 1, wherein the realistically reproducing device comprises at least one of a two-dimensional (2D) image reproducing device, a three-dimensional (3D) image reproducing device, an audio reproducing device, a fragrance generating apparatus and a vibration generating apparatus.

9. The apparatus of claim 1, the immersive media gateway maps each of the one or more realistically reproducing devices with each modality for reproduction based on curation information included in the received scenario.

10. The apparatus of claim 1, wherein the immersive media gateway operates in sync with the one or more realistically reproducing devices.

11. A method for providing realistic broadcasting, the method comprising:
searching for one or more realistically reproducing devices which is currently available, and generating realistically reproducing device information;
generating sensory content by curating each of one or more modalities in received content;
generating a scenario based on the sensory content and the realistically reproducing device information;
configuring a realistic broadcasting space based on the generated scenario; and
providing a realistic broadcasting service to a user using one or more realistically reproducing devices composing the realistic broadcasting space.

12. The method of claim 11, wherein the generating of the scenario comprises
converting the received content into the sensory content by curating curation information included in the content according to each modality of the content; and
generating the scenario by reflecting a predefined realistic service policy or a user's preference service request to the converted sensory content.

13. The method of claim 11, wherein the generating of the realistically reproducing device information comprises
calculating location information indicating a physical location of a mobile terminal of a user;
searching for one or more realistically reproducing devices accessible on a network based on the location information and performing polling for the found realistically reproducing devices; and
generating the realistically reproducing device information about the found realistically reproducing devices.

14. The method of claim 11, wherein the one or more realistically reproducing devices are found based on Internet Protocol (IP) addresses.

15. The method of claim 11, wherein the one or more realistically reproducing devices are connected to a home network according to address system of the home network.

16. The method of claim 11, wherein the generating of the scenario comprises curating the received content to convert curation information to be suitable for modalities of the content, and, if the content is sensory content, curating the content by adding information corresponding to each modality thereof.

17. The method of claim 11, wherein the realistically reproducing device comprises at least one of a two-dimensional (2D) image reproducing device, a three-dimensional (3D) image reproducing device, an audio reproducing device, a fragrance generating apparatus and a vibration generating apparatus.

18. The method of claim 11, further comprising
mapping each of the one or more realistically reproducing devices with each modality for reproduction based on curation information included in the received scenario.

19. The method of claim 11, wherein the providing of a realistic broadcasting service to the user using the one or more realistically reproducing devices comprises synchronizing the one or more realistically reproducing devices.
